(19) United States
(12) Patent Application Publication
(10) Pub. No.: US 2016/0288268 A1
(43) Pub. Date: Oct. 6, 2016

(54) A METHOD OF BONDING OPTICAL FIBERS WITH CONDUCTIVE COATINGS WITH METAL ELEMENTS

(71) Applicants: INPHOTECH SP. O. O., Warszawa (PL); FIBRAIN SP. Z O. O., Rzeszów (PL)

(72) Inventors: Katarzyna GIBALA, Rzeszow (PL); Jan KALISZ, Rzeszow (PL); Tomasz NASILOWSKI, Warszawa (PL); Alicja LESKO, Rzeszow (PL); Anna LOZANSKA, Bratkowice (PL); Katarzyna Joanna PAWLIK, Warszawa (PL); Malgorzata OLSZEWSKA, Warszawa (PL); Zbigniew HOLDYNSKI, Warszawa (PL); Michal MURAWSKI, Warszawa (PL); Lukasz OSTROWSKI, Nieporet (PL); Michal SZYMANSKI, Warszawa (PL); Tadeusz TENEDERENDA, Warszawa (PL); Marek NAPIERALA, Wroclaw (PL); Michal DLUBEK, Annopol (PL); Tomasz STANCZYK, Piaseczno (PL); Karol WYSOKINSKI, Gdynia (PL)

(73) Assignee: INHOTECH SP.O.O., Warszawa (PL)

(21) Appl. No.: 15/038,376

(22) PCT Filed: Nov. 22, 2014
(86) PCT No.: PCT/PL2014/050074

§ 371 Date: May 20, 2016

(30) Foreign Application Priority Data
Nov. 22, 2013 (PL) P.406197

(51) Int. Cl. B23K 28/00; G02B 6/42; C25F 1/00

(52) U.S. Cl. CPC B23K 28/006; C25F 1/00; G02B 6/424

(57) ABSTRACT

A method of connecting optical fibers coated with conductive layer, preferably metalized, with metal elements, comprising the following stages: 1. preparing the electrolyte, 2. clearing the optical fiber surface and clearing the electrodes, 3. placing the optical fiber and the metal sensor element in the electrolyzer, 4. enabling flow of electricity, 5. cleaning the elements—the optical fiber element bonded to the metal element.

The subject of the invention is a method of connecting optical fibers coated with conductive layer with metal elements.

Optical fibers are commonly bonded to sensor elements using the arc welding techniques or using other means, such as mechanic joints, which are connected to the optical fiber elements included in sensors. Unfortunately, these require direct optical fiber-metal connection, particularly when metal, to which the optical fiber is bonded, is an active element of the sensor, e.g. in a tension sensor or temperature sensor.

The physical and chemical properties of glass, a standard material used to produce optical fiber, create an challenging environment for bonding elements other than glass itself. The application of optical fibers in sensors with active metal or metalized elements therefore requires the use of optical fibers with metal or metalized coating, or, at least, a shield in the form of metal braiding or, first and foremost, optical fiber surface activation comprising a metal layer. Another method of metal-plating optical fiber (e.g. with copper) is coating the optical fiber during the drawing process. In the case of polymer-coated optical fibers, the most popular method of connecting them to other materials is gluing.

Patent claim number PL 134228 specifies a bath for producing electrolytic, glossy copper coatings characterized by very high surface smoothness, which are not affected by tensions causing the metallic coating to break.

According to a description in patent number EP19840113862, material surface is covered with a metal layer in a copper-plating galvanic bath, allowing for highly efficient production of copper coatings, without losing the electrical properties of zinc plated copper.

In turn, patent claim number EP1283282 presents a method of galvanizing printed circuits, in which the temperature of the solution is lowered to 25° C.

In turn, in mechanic methods, in which the metal element of the sensor is clamped on the optical fiber, the joint is limited to partial stabilization of the optical fiber which, in the case of excessive tightening of the metal element on the optical fiber, may lead to damaging the optical fiber. If, on the other hand, the clamp is tightened too loosely on the optical fiber, the optical fiber-metal joint will not transmit the signal recorded by the sensor. However, the purpose of mechanical bonding of optical fiber and the sensor is often to immobilize the optical fiber only, without transmitting any signals to the optical fiber.

Electrolysis is a widespread method used for metal plating, aimed at raising their resistance to corrosion, abrasion or reducing their proneness to deformations. Electrolysis is also applied in electrochemical batteries, such as lithium-ion batteries. It was quite early indicated that the use of a pure lithium battery results in the formation of dendrites which grow with every battery operation cycle, ultimately resulting in the origination of a bridge between the two electrodes causing short-circuits. Although undesirable, such link has proven that is it possible to bond elements using electrolysis. One of the methods applied in intentional bonding of i. a. damaged fragments of metal objects is brush plating, which is a variant of electrolytic plating, in which the electrolyte is not situated in a container, but in a porous material, with which the anode is covered (Derek Vanek. An update on brush plating. Metal finishing, 2002, 100(7), pages 18-20)

This method is used for repairing damaged elements or filling material cavities at low temperatures. The method applies a universal anode, which is suitable for spot covering of various objects. However, it has a disadvantage, namely in the contact of the plated material with the anode, which is unfavorable when the plated element is delicate or when its dislocation is highly undesirable. Therefore, when requiring precise optical fiber treatment, the popular metal plating method (U.S. Pat. No. 5,048,919 A, U.S. Pat. No. 5,311,610 A) was used. The above specified patents required high precision and a low-temperature environment for the procedure. This was possible thanks to the use of electrolytic plating with the use of dedicated supports positioning the optical fiber. The above specified studies described and patented only the methods for fixing optical fibers to electro-optical devices, such as e.g. lasers, which constitutes a useful method of coupling. This is however not required in this invention, since light does not need to be introduced to the optical fiber. A bonding technique is used to affix the optical fiber with conductive layer to a metal element of the sensor, which has not been published elsewhere yet. Moreover, contrary to U.S. Pat. No. 5,311,610 A, the use of conductive gel is not required, as the connected elements are brought in tight contact in the process of plating. This constitutes considerable progress, since it allows for the use of such sensor in high temperatures, in which polymer gel would undergo decomposition.

Methods of connecting optical fibers to elements made of other materials, e.g. metal elements of sensors, for instance methods of producing metal or metalized coatings, are known to those skilled in the art. Although they allow for producing high quality coatings on the majority of materials, they are unsuitable for creating a high-quality metallic coating on the surface of optical fiber, due to low adhesion of the coating to the optical fiber surface. Furthermore, due to general use of cheaper and more precise metal active elements rather than composite elements in sensor components, it would be justified to develop a method for connecting optical fiber with metal elements of the sensors in a way as to enable detection and recording of the condition of the sensor.

A method of connecting optical fibers coated with conductive coatings, preferably metalized, with metal elements assumes the following stages:
1. preparing the electrolyte,
2. clearing the conductive, preferably metalized, optical fiber surface and clearing the electrodes,
3. placing the optical fiber and the metal sensor element in the electrolyzer,
4. enabling flow of electricity,
5. cleaning the elements—the optical fiber element bonded to the metal element.

The stage of preparing the electrolyte consists in producing an electrolyte with a concentration of 0.5 to 2 mol/dm³, selected from available sulfate, cyanide, fluoroborate, fluorosilicate, sulfamate, alkyl sulfonate, oxalate, formate, iodide, thiosulfate, pyrophosphate, thiocyanate, tartrate, fluoride, chloride, bromide, chromate, hydroxide, ethylenediamine, chlorate, perchlorate, bromate, iodate, sulfite, acetate, nitrate, nitrite, phosphate, fluorophosphate, selenate, fluoroaluminate, amine electrolytes, or similar baths containing pyridine, acetylacetone, ethanolamine, quinoline, imidazole, pyrrole complexes or ethylenediaminetetraacetic, citric, succininc, malic, lactic, propanoic acid, amino acids or similar substances. In a beneficial embodiment, the electrolyte is prepared as a sulfate solution containing a solution of hydrated copper sulfate with distilled water. However, depending on the preferred reaction speed and temperature conditions, from 125 to 500 g of hydrated copper sulfate is dissolved in 1 dm³ of distilled water. The solution is heated, mixing continuously, and ensuring that the temperature of 50° C. is not exceeded. After dissolving the copper sulfate, from 25 to 75 g of sulfuric acid is poured to the solution.

The metal element connected to the optical fiber is degreased, preferably using an electrochemical method, and then brought in contact with the optical fiber with conductive coating, preferably metalized, which must be previously cleaned, preferably by degreasing with acetone.

Electrolyzer anode is cleared out of oxides deposited on its surface. A nitric acid (65%) and distilled water solution is prepared (volume proportion of 1:1), and the anode is dipped in a basin filled with the said solution. After the oxides decompose, the anodes are extracted from the solution and rinsed with distilled water.

Optical fibers, brought in contact with the metal element of the sensor, are then placed in the prepared solution, poured into the electrolyzer. The shape and the dimensions of the electrolyzer enable complete submersion (bath-dipping) of connected optical fiber and metal elements. After placing the connected optical fiber and metal elements in the electrolyzer, the cleared electrode is inserted into an electrolyzer vessel and then copper pieces are added to increase anode surface.

Filled with the electrolyte, the electrolyzer with the anode and copper pieces is connected to power supply, after which the process of electrolysis is carried out for at least 1 hour. In a beneficial embodiment, the intensity of the current passing through the electrolyte is from 10 to 22 mA, and the temperature of the electrolyte is maintained at 15 to 45° C. In a beneficial embodiment, the duration of electrolysis does not exceed 2.5 h. By changing the parameters of voltage, current, composition and concentration of electrolyte, brighteners, the temperature and duration of the process, one can control the parameters of the joint (thickness, granulation, hardness, smoothness, plasticity, durability—resistance, increase velocity, the application of modulated current), depending on the needs. However, in order to increase the thickness of the layer obtained through electrolysis, the current intensity and the time of electrolysis must be increased. In order to obtain higher granulation of the electrolytic coating, current intensity and electrolyte temperature must be increased.

A change in signal propagation in the optical fiber occurs depending on the parameters recorded by the sensor. In the case of metal element and optical fiber joints according to the invention, any metal element deformations and the resulting tensions (whether resulting from temperature changes, pressure on the surface, to which metal is affixed, or other factors) are always transmitted to the optical fiber and, after being collected by the device interpreting signal change, transformed into the measurements of temperature, dislocation, pressure, etc.

### EXAMPLE I

A method of connecting optical fibers coated with conductive layer with metal elements comprises the following stages:
1. preparing the electrolyte,
2. clearing the optical fiber surface and clearing the electrodes,
3. placing the optical fiber and the metal sensor element in the electrolyzer,
4. enabling flow of electricity,
5. cleaning the elements—the optical fiber element bonded to the metal element.

Preparation of electrolyte consists of producing an electrolyte with a concentration of 0.5 mol/dm³ as a sulfate solution containing a solution of hydrated copper sulfate with distilled water. However, 125 g of hydrated copper sulfate is dissolved in 1 dm³ of distilled water. The solution is heated up, mixing continuously, and ensuring that the temperature of 50° C. is not exceeded. After dissolving the copper sulfate, 25 g of sulfuric acid is poured to the solution.

The metal element to be connected is degreased, preferably using an electrochemical method, and then brought in contact with the optical fiber, which must be previously cleaned, preferably by degreasing with acetone.

Electrolyzer anode is cleared out of oxides deposited on its surface. A nitric acid (65%) and distilled water solution is prepared (volume proportion of 1:1), and the anode is dipped in a basin filled with the said solution. After the oxides decompose, the anodes are extracted from the solution and rinsed with distilled water.

Optical fibers, brought in contact with the metal element of the sensor, are then placed in the prepared solution poured into the electrolyzer. The shape and the dimensions of the electrolyzer enable complete submersion (bath-dipping) of connected optical fiber and metal elements. After placing the connected optical fiber and metal elements in the electrolyzer, the cleared electrode is inserted into an electrolyzer vessel and then copper pieces are added to increase anode surface.

Filled with the electrolyte, the electrolyzer with the anode and copper pieces is connected to power supply, after which the process of electrolysis is carried out. The intensity of the current passing through the electrolyte is 10 mA, and the temperature of the electrolyte is maintained at 15° C. By changing the parameters of voltage, current (type, composition and concentration of electrolyte, brighteners), temperature and duration of the process, one can control the parameters of the joint (thickness, granulation, hardness, smoothness, plasticity, durability, increase velocity, the application of modulated current), depending on the needs. However, in order to increase the thickness of the layer obtained through electrolysis, the current intensity and the time of electrolysis must be increased. In order to obtain higher granulation of the electrolytic coating, current intensity and electrolyte temperature must be increased.

A change in signal propagation in the optical fiber occurs depending on the parameters recorded by the sensor. In the case of metal element and optical fiber joints according to the invention, any metal element deformations and the resulting tensions (whether resulting from temperature changes, pressure on the surface, to which metal is affixed, or other factors) are always transmitted to the optical fiber and, after being collected by the device interpreting signal change, transformed into the measurements of temperature, dislocation, pressure, etc.

### EXAMPLE II

A method of connecting optical fibers coated with conductive layer with metal elements comprises the following stages:
1. preparing the electrolyte,
2. clearing the optical fiber surface and clearing the electrodes,
3. placing the optical fiber and the metal sensor element in the electrolyzer,
4. enabling flow of electricity,
5. cleaning the elements—the optical fiber element connected to the metal element.

Preparation of electrolyte consists of producing an electrolyte with a concentration of 2 mol/dm³ as a sulfate solution containing a solution of hydrated copper sulfate with distilled water. However, 500 g of hydrated copper sulfate is dissolved in 1 dm³ of distilled water. The solution is heated up, mixing continuously, and ensuring that the temperature of 50° C. is not exceeded. After dissolving the copper sulfate, 75 g of sulfuric acid is poured to the solution.

The metal element to be connected with the optical fiber is degreased, preferably using an electrochemical method, and then brought in contact with the optical fiber, which must be previously cleaned, preferably by degreasing with acetone.

Electrolyzer anode is cleared out of oxides deposited on its surface. A nitric acid (65%) and distilled water solution is prepared (volume proportion of 1:1), and the anode is dipped in a basin filled with the said solution. After the oxides decompose, the anodes are extracted from the solution and rinsed with distilled water.

Optical fibers, brought in contact with the metal element of the sensor, are then placed in the prepared solution, poured into the electrolyzer. The shape and the dimensions of the electrolyzer enable complete submersion (bath-dipping) of connected optical fiber and metal elements. After placing the connected optical fiber and metal elements in the electrolyzer, the cleared electrode is inserted into an electrolyzer vessel and then copper pieces are added to increase anode surface.

Filled with the electrolyte, the electrolyzer with the anode and copper pieces is connected to power supply, after which the process of electrolysis is carried out. The intensity of the current passing through the electrolyte is 22 mA, and the temperature of the electrolyte is maintained at 45° C. The duration of electrolysis is 2.5 h. By changing the parameters of voltage, current (type, composition and concentration of electrolyte, brighteners), the temperature and duration of the process, one can control the parameters of the joint (thickness, granulation, hardness, smoothness, plasticity, durability, increase velocity, the application of modulated current), depending on the needs. However, in order to increase the thickness of the layer obtained through electrolysis, the current intensity and the time of electrolysis must be increased. In order to obtain higher granulation of the electrolytic coating, current intensity and electrolyte temperature must be increased.

A change in signal propagation in the optical fiber occurs depending on the parameters recorded by the sensor. In the case of metal element and optical fiber joints according to the invention, any metal element deformations and the resulting tensions (whether resulting from temperature changes, pressure on the surface, to which metal is affixed, or other factors) are always transmitted to the optical fiber and, after being collected by the device interpreting signal change, transformed into the measurements of temperature, dislocation, pressure, etc.

1. A method of bonding optical fibers, comprising
bonding optical fibers coated with a conductive layer with metal elements through electrolysis.

2. The method of claim 1 wherein a stage of preparing the electrolyte comprises producing an electrolyte with a concentration of 0.5 to 2 mol/dm3, from sulfate, cyanide, fluoroborate, fluorosilicate, sulfamate, alkyl sulfonate, oxalate, formate, iodide, thiosulfate, pyrophosphate, thiocyanate, tartrate, fluoride, chloride, bromide, chromate, hydroxide, ethylenediamine, chlorate, perchlorate, bromate, iodate, sulfite, acetate, nitrate, nitrite, phosphate, fluorophosphate, selenate, fluoroaluminate, amine electrolytes, or similar baths containing pyridine, acetylacetone, ethanolamine, quinoline, imidazole, pyrrole complexes or ethylenediaminetetraacetic, citric, succininc, malic, lactic, propanoic acid, amino acids or combinations thereof.

3. The method of claim 1, further comprising the following stages:
preparing a electrolyte,
clearing an optical fiber surface and clearing electrodes,
placing the optical fiber and the metal sensor element in an electrolyzer,
enabling flow of electricity,
cleaning the elements, including the optical fiber element connected to the metal element.

4. The method of claim 1, wherein the electrolyte is prepared as a sulfate solution containing a solution of hydrated copper sulfate with distilled water.

5. The method of claim 1, wherein 125 to 500 g of hydrated copper sulfate is dissolved in 1 dm3 of distilled water, then heated, mixing continuously, and ensured that the temperature of 50° C. is not exceeded, and after dissolving the copper sulfate, from 25 to 75 g of sulfuric acid is poured to the solution.

6. The method of claim 1, wherein the metal element to be connected with the optical fiber is degreased, and then brought in contact with the optical fiber, which is previously cleaned.

7. The method of claim 6, wherein the metal element and the optical fiber are degreased using the electrochemical method

8. The method of claim 6, wherein the metal element and the optical fiber are degreased with acetone

9. The method of claim 6, wherein the metal element and the optical fiber are degreased using the electromechanical method and with acetone

10. The method of claim 1, wherein the electrolyzer anode is cleared out of oxides deposited on its surface with a nitric acid (65%) and distilled water solution, which is prepared (volume proportion of 1:1), and the anode is dipped in a basin filled with the said solution, and that after the oxides decompose, the anodes are extracted from the solution and rinsed with distilled water.

11. The method of claim 1, wherein optical fibers, brought in contact with the metal element of the sensor, are placed in the prepared solution, poured into the electrolyzer, and filled with the electrolyte, the electrolyzer with the anode and copper pieces are connected to a power supply.

12. The method of claim 11, wherein electrolysis is carried out for at least 1 hour.

13. The method of claim 11, wherein the intensity of the current passing through the electrolyte is from 10 to 22 mA, and the temperature of the electrolyte is maintained at 15 to 45° C.

14. (canceled)
